(19) United States
(12) Patent Application Publication
(10) Pub. No.: US 2009/0301300 A1
(43) Pub. Date: Dec. 10, 2009

(54) Gas Dryer

(75) Inventor: Guy Couturier, Blainville (CA)

Correspondence Address: BRADLEY ARANT BOULT CUMMINGS LLP;INTELLECTUAL PROPERTY DEPARTMENT, 1819 FIFTH AVENUE NORTH, BIRMINGHAM, AL, 35203-2104, US

(73) Assignee: XEBEC ADSORPTION, INC., Blainville (CA)

(21) Appl. No.: 12/239,604

(22) Filed: Sep. 26, 2008

(30) Foreign Application Priority Data
Jun. 5, 2008 (CA) 2633521

(51) Int. Cl. B01D 53/02

(52) U.S. Cl. 95/104; 96/144

(57) ABSTRACT

A gas dryer having an inlet for receiving a wet gas; at least one vessel containing at least a desiccant for absorbing moisture from a wet gas passing through the desiccant in a first direction under pressure and for desorbing the desiccant by passing a second gas under a partial vacuum in a direction counter to the first direction during a warming and a cooling phase of regeneration; a means for generating a partial vacuum in the vessel; and an outlet for expelling dried gas from the vessel.

This patent application claims priority under the Paris Convention from Canadian Patent Application No. 2,633,521, filed Jun. 5, 2008.

### FIELD OF THE INVENTION

This invention relates to gas dryers that remove moisture from gas.

### BACKGROUND

Gas dryers for drying wet gas have been used in the industry for many years. Generally, there are four conventional dryer types in industry: (1) heatless dryers; (2) heated dryers; (3) blower purge dryers; and (4) vacuum purge dryers. The most energy efficient of the four is the vacuum purge dryer.

Examples of specific gas dryers are discussed in the following patents and applications:

German Patent No. DE 3720915C2 (“Sabroe”), issued on Jun. 25, 1987, discloses a vacuum purge dryer that uses down flow warming under pressure and up flow cooling under vacuum during the regeneration phase.

German Patent Application No. DE 19720103A1 (“Zander DE '103”) discloses a vacuum purge dryer that is almost identical to the Sabroe patent, but uses partial vacuum to direct cool air through the regeneration vessel in the cooling phase.

German Patent No. DE 19720104C2 (“Zander DE '104”), issued on May 14, 1997 discloses a dryer which operates on a co-current flow basis.

Previous gas dryers do not disclose down flow drying and up flow regeneration using ambient air. Furthermore, previous vacuum purge dryers do not disclose counter-current drying and regeneration under a vacuum.

### SUMMARY OF THE INVENTION

This invention discloses a gas dryer having an inlet for receiving a wet gas, at least a vessel containing at least a desiccant for absorbing moisture from a wet gas passing through the desiccant in a first direction under pressure and for desorbing the desiccant by passing a second gas under a partial vacuum in a direction counter to the first direction during the warming and cooling phase of regeneration, vacuum means for generating a partial vacuum in the vessel, and an outlet for expelling the (dried) gas from the vessel.

Wet gas is dried by passing the wet gas through a desiccant in a first direction to be dried, absorbing moisture from the gas into the desiccant, expelling the dried gas, passing a dry gas through the desiccant under partial vacuum in a direction counter to the first direction for regenerating the desiccant.

In an embodiment of the invention, wet gas is dried by down flow drying and up flow regeneration using ambient air.

By drawing gas in a down flow direction during the drying stage, gas can travel through the desiccant beds at an increased velocity, which reduces drying time by up to 15%. Down flow drying also prevents the dislodging of desiccant during the drying stage.

The use of counter-current flow is also beneficial. Down flow drying and counter up flow regeneration improves the energy efficiency of the dryer since wet gas can be removed from the system quicker. Furthermore, this invention also allows the vessels to be downsized.

### BRIEF DESCRIPTION OF THE DRAWINGS

FIG. 1 is a schematic diagram of one embodiment of this invention.

### DETAILED DESCRIPTION OF THE INVENTION

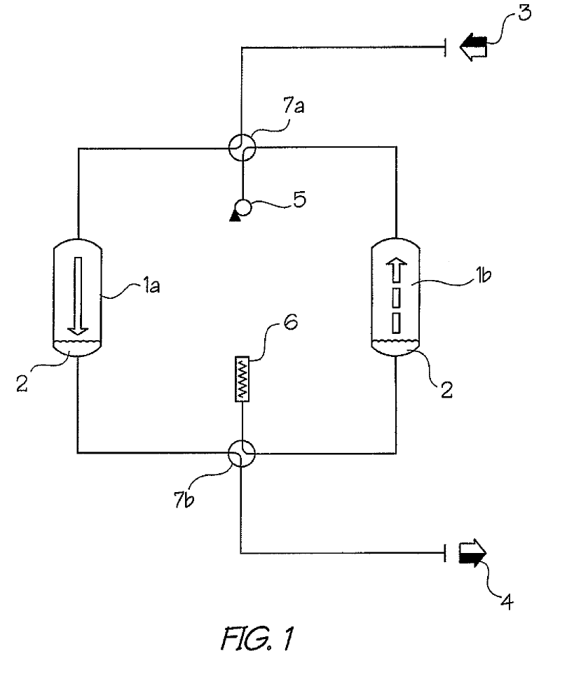

With reference to FIG. 1, in a preferred embodiment, the invention relates to a vacuum purge drying system having two vessels 1a and 1b that each contains a desiccant 2 for absorbing moisture from a gas. In FIG. 1, 1a is the drying vessel for drying wet gas while 1b is the regeneration vessel for regenerating the desiccant 2. It will be understood, however, that at any given time, the role of the vessels 1a and 1b can be reversed with 1a functioning as the regeneration vessel and 1b functioning as the drying vessel.

In FIG. 1, the gas flow in the drying vessel 1a runs counter-current to gas flow in the regeneration vessel 1b. Preferably, wet gas, which may be compressed gas, enters from an inlet 3 at the top of the system and passes in a downward direction (down flow), as shown by the downward arrows in FIG. 1, through the drying vessel 1a and exits from an outlet 4 at the bottom of the system.

The desiccant 2 in the drying vessel 1a eventually becomes saturated with moisture and must be regenerated by drying. Preferably, there are two phases to the regeneration step: (1) a warming phase which uses warn gas; and (2) a cooling phase which uses cooled gas. The gas used in the regeneration step is preferably ambient air. The warming phase of regeneration takes place by having a vacuum means 5 draw heated or warmed gas through the desiccant 2 in the regeneration vessel 1b in a direction counter to the direction of flow in the drying vessel 1a, as shown by the stippled upward arrows in FIG. 1. Preferably, gas flow in the regeneration vessel 1b is upward. This ensures that the desiccant is sufficiently desorbed of the moisture from the wet gas. The cooling phase of regeneration begins when the gas flowing through the regeneration vessel 1b reaches a predetermined temperature (in one embodiment, typically 100-160 degrees F.) and the heater 6 heating the gas is turned off to allow the gas to cool. The vacuum means 5 would continue to draw cooled gas or ambient air upward through the desiccant 2 in the regeneration vessel 1b. Alternatively, cooled gas can be drawn through the desiccant in the regeneration vessel 1b. It will be understood by those skilled in the art that the heating and cooling temperatures can be varied as needed.

At any given time, one of the vessels is drying gas while the other is undergoing regeneration whereby wet desiccant in the regeneration vessel 1b is being desorbed. After each cycle of drying and simultaneous regeneration, the switching valves 7a and 7b change position so that the drying vessel 1a begins the regeneration phase and the regeneration vessel 1b begins the drying phase.

What is claimed is:

1. A gas dryer comprising:
an inlet for receiving a wet gas;
at least one vessel containing at least a desiccant for absorbing moisture from a wet gas passing through the desiccant in a first direction under pressure and for desorbing the desiccant by passing a second gas under a partial vacuum in a direction counter to the first direction during a warming and a cooling phase of regeneration;
vacuum means for generating a partial vacuum in the vessel; and
an outlet for expelling dried gas from the vessel.

2. A gas dryer as claimed in claim 1 further comprising one or more switching valves for changing the inlet to the outlet whereby the vessel that undergoes absorption of moisture from the wet gas changes to a vessel that undergoes desorption and vice versa.

3. A gas dryer as claimed in claim 1, comprising a drying vessel and a separate regeneration vessel.

4. A gas dryer as claimed in claim 3 wherein the drying vessel and the regeneration vessel are in parallel.

5. A gas dryer as claimed in claim 1, wherein the second gas is ambient air.

6. A gas dryer as claimed in claim 1, further comprising a heater for heating the ambient air or the second gas to a predetermined temperature.

7. A gas dryer comprising:
an inlet for receiving a wet gas;
at least a vessel containing at least a desiccant for absorbing moisture from a wet gas passing through the desiccant in a downward direction and for desorbing the desiccant by passing ambient air in an upward direction;
an outlet for expelling dried gas from the vessel.

8. A gas dryer as claimed in claim 7, wherein desorption of the desiccant occurs under pressure.

9. A gas dryer as claimed in claim 7, wherein desorption of the desiccant occurs under partial vacuum.

10. A gas dryer comprising:
an inlet for receiving a wet gas;
at least a vessel containing at least a desiccant for absorbing moisture from a wet gas passing through the desiccant in a downward direction and for desorbing the desiccant by passing a second gas in an upward direction under partial vacuum;
vacuum means for generating a partial vacuum in the vessel; and
an outlet for expelling dried gas from the vessel.

11. A method of drying wet gas comprising the steps of:
(a) passing a first wet gas through a desiccant in a first direction to be dried;
(b) absorbing into the desiccant at least a portion of the moisture in the gas;
(c) expelling dried gas;
(d) passing a second gas through the desiccant in a direction counter to the first direction under partial vacuum; and
(e) regenerating the desiccant.

12. A method as claimed in claim 11, wherein the regeneration step further comprises a warming phase, whereby the second gas is warm, and a cooling phase, whereby the second gas is cooled.

13. A method as claimed in claim 12, further comprising the steps of heating the second gas to a predetermined temperature and cooling the second gas once the temperature of the second gas reaches the predetermined temperature.

14. A method as claimed in claim 11, wherein the second gas is ambient air.

15. A gas dryer comprising:
an inlet for receiving a wet gas;
at least one vessel containing at least a desiccant for absorbing moisture from a wet gas passing through the desiccant in a first direction under pressure and for desorbing the desiccant by passing a second gas under a partial vacuum in a direction counter to the first direction during a warning and a cooling phase of regeneration;
a vacuum generator for generating a partial vacuum in the vessel; and
an outlet for expelling dried gas from the vessel.

16. A gas dryer comprising:
an inlet for receiving a wet gas;
at least a vessel containing at least a desiccant for absorbing moisture from a wet gas passing through the desiccant in a downward direction and for desorbing the desiccant by passing a second gas in an upward direction under partial vacuum;
a vacuum generator for generating a partial vacuum in the vessel; and
an outlet for expelling dried gas from the vessel.
